(19) United States
(12) Patent Application Publication
(10) Pub. No.: US 2006/0177107 A1
(43) Pub. Date: Aug. 10, 2006

(54) Image input apparatus and person authentication system using an image input apparatus

(75) Inventor: Takayuki Ishii, Hiratsuka-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/338,077

(22) Filed: Jan. 24, 2006

(30) Foreign Application Priority Data
Feb. 9, 2005 (JP) 2005-033091

(51) Int. Cl. G06K 9/00

(52) U.S. Cl. 382/115

(57) ABSTRACT

A blood vessel image input apparatus is provided which is capable of acquiring a high-precision image of blood vessels of a body part, such as a finger, even if the finger is swept at a non-constant speed. The apparatus includes a solid-state line image sensor, a light source for illuminating the inside of the finger with light, an imaging optical system adapted to focus the light, emitted from the light source and passed through the inside of the finger, on the solid-state line image sensor such that a blood vessel image representing a network structure of veins in the finger is formed on the solid-state line image sensor, and a blood vessel image forming unit adapted to form a complete image of blood vessels by connecting a plurality of partial blood vessel images captured by the solid-state line image sensor while sweeping the finger.

### BACKGROUND OF THE INVENTION

1. Field of the Invention

The present invention relates to an image input apparatus adapted to acquire an image of blood vessels of a finger of a person to be authenticated by detecting, using a solid-state image sensor, light emitted from a light source and passing through the finger, and to a person authentication system using such an image input apparatus. And more particularly, the present invention relates to an image input apparatus adapted to acquire an image of blood vessels of a finger of a person to be authenticated, by detecting, using a solid-state image sensor, light emitted from a light source and passing through the finger while moving the relative position between the finger and the solid-state image sensor, and to a person authentication system using such an image input apparatus.

2. Description of the Related Art

In recent years, with advances in information technology, business activities using e-commerce have become popular. In e-commerce, there is a need to electronically perform person authentication to prevent information from being fraudulently used.

One known technique of electronically authenticating a person is to use an image of blood vessels of a hand. For example, Japanese Patent Laid-Open No. 10-295674 (corresponding to U.S. Pat. No. 6,301,375) discloses a technique in which an image of veins of the back of a hand is used. Japanese Paten Laid-Open No. 2004-062826 (corresponding to U.S. patent application publication US 2004/0022421 A1) discloses a technique in which an image of veins of the palm of a hand is used. In this type of blood vessel image input apparatus, to acquire an image of the back or the palm of a hand, a two-dimensional image sensor is used as an imaging unit. However, in an apparatus using a two-dimensional image sensor as an imaging unit, to acquire an image via an optical image forming system, the two-dimensional image sensor has to have a large size, which results in an increase in the total size of the apparatus.

As a technique to prevent an increase in the size of the imaging apparatus, Japanese Patent Laid-Open No. 2004-265269 (corresponding to U.S. patent application publication US 2004/0184641 A1) discloses a blood vessel image input apparatus for inputting an image of blood vessels of a finger. FIGS. 10 and 11 illustrate the image input apparatus for inputting an image of veins of a finger in accordance with Japanese Patent Laid-Open No. 2004-265269.

In the blood vessel image input apparatus shown in FIG. 10, a finger 102 is illuminated with light emitted via a light source opening 104 from a near-infrared light source 114 of a light source unit 104 disposed in a case 100. Via an image-sensing opening 110, a camera 112 captures an image of blood vessels using light passing through the inside of the finger. Additionally, reference numeral 116 denotes a light blocking plate, and reference numeral 118 denotes a guide groove.

In the aforementioned blood vessel image input apparatus shown in FIG. 10, in order to take a complete image of a whole finger from its tip to base, although not explicitly described in Japanese Patent Laid-Open No. 2004-265269, the imaging unit needs a two-dimensional image sensor having an image sensing area with a size corresponding to the size of the finger.

FIG. 11 shows, in a simplified manner, the relationship between the camera 112 and the finger 102 in the image sensing area. In the blood vessel image input apparatus, as can be seen from FIG. 11, the image sensing area (image acquisition area) 300 has to be large enough to capture a complete image of a whole finger at a time. As shown in FIG. 11, to capture an image of a whole finger 102, a two-dimensional image sensor 120 used as the imaging unit of the camera 112 and the imaging optical system 121, which focuses incident light such that the finger image is formed on the two-dimensional image sensor 120, are located apart from the finger 102.

To achieve a small total size, Japanese Patent Laid-Open No. 2004-265269 also discloses a folded structure using a mirror. However, in the structure disclosed in Japanese Patent Laid-Open No. 2004-265269, use of the two-dimensional image sensor as the image sensor and the disclosed optical structure folded in an unoptimized direction do not allow a sufficient reduction in the size.

A known technique to reduce the size of the imaging apparatus is to use a sweep-type blood vessel image input apparatus, which takes an image of blood vessels of a finger while sweeping the finger to be examined, using a solid-state line image sensor. FIG. 12 shows an example of such a sweep-type blood vessel image input apparatus. In the example shown in FIG. 12, the sweep-type blood vessel image input apparatus includes a solid-state line image sensor 122, and an imaging optical system 123 that focuses incident light on the solid-state line image sensor 122 such that an image is formed thereon.

In the sweep-type blood vessel image input apparatus shown in FIG. 12, a plurality of blood vessel images are acquired in a short time; while sweeping a finger 102 (as represented by a double dashed line arrow a1 in FIG. 12), and a complete image of the whole finger is acquired by connecting the plurality of images. When the solid-state line image sensor 1 is used as the imaging unit, the image sensing area (image acquisition area) 301 of this imaging unit is smaller than the image sensing area 300 of the two-dimensional image sensor 120. However, the blood vessel image input device of the sweep type has an additional advantage that its size is small.

On the other hand, in the above-described conventional blood vessel image input apparatus using the two-dimensional solid-state image sensor, because it is required that the image sensing area of the two-dimensional image sensor should be large enough to capture a complete image of a whole finger, it is difficult to reduce the size of the apparatus, although it has the advantage that a complete image of a whole finger can be captured at a time.

In contrast, in the above-described sweep-type blood vessel image input apparatus, because an image is captured using the solid-state line image sensor while sweeping a finger, the image sensing area does not need to have a size corresponding to the whole finger. Although this structure allows a reduction in the size of the apparatus, only an image of a part of a finger is obtained at a time. Therefore, to obtain a complete image of blood vessels of a whole finger, it is necessary to perform an image taking operation a plurality of times, and connect the plurality of finger images. To correctly connect images, information is necessary that represents the relative positional relationship among the plurality of blood vessel images.

However, because a plurality of images of blood vessels of a finger of a person (a subject) to be authenticated are taken by the sweep-type blood vessel image input apparatus while the finger is swept by the person, the sweeping speed of the finger is not constant. The non-constant sweeping speed of the finger causes the relative positional relationships among the plurality of images of blood vessels to become indefinite, and thus, a simple connection of a plurality of captured images of blood vessels does not allow achievement of a complete image with high precision.

### SUMMARY OF THE INVENTION

In view of the above, the present invention provides a small-sized blood vessel image input apparatus capable of acquiring a complete image with high precision. The present invention also provides a blood vessel image input apparatus capable of acquiring a complete image with high precision even if a finger is swept at a non-constant speed.

More specifically, according to an embodiment of the present invention, there is provided an image input apparatus including an imaging unit including at least one line of image sensing elements, and a light source adapted to illuminate an object to be examined with light, whereby an image of blood vessels is acquired by passing the light through the inside of the object to be examined, and the image is captured by the imaging unit, wherein a plurality of image signals of respective partial images of blood vessels captured by the imaging unit are sequentially read while sweeping the object to be examined, and a complete image of blood vessels is formed by connecting the partial images of blood vessels represented by the respective read image signals.

In another aspect of the present invention, the image input apparatus may further include a sweeping amount detection unit configured to detect the sweeping amount of the object to be examined. The image input apparatus may further include a blood vessel image forming unit configured to form a complete blood vessel image by connecting the plurality of partial blood vessel images, depending on the sweeping amount of the object to be examined detected by the sweeping amount detection unit.

In the image input apparatus, the sweeping amount detection unit may detect the sweeping amount in a state in which the sweeping amount detection unit is in contact with the object to be examined. Moreover, in the image input apparatus, the sweeping amount detection unit may be in a form of a contacting and rotating roller, a contact-type optical position sensor, or a contact-type capacitive position sensor.

In the image input apparatus, the sweeping amount detection unit may detect the sweeping amount in a state in which the sweeping amount detection unit is not in contact with the object to be examined. Further, the sweeping amount detection unit may illuminate the surface of the object to be examined with light and detects the sweeping amount based on a change in the image of the surface shape of the object to be examined.

The sweeping amount detection unit may also serve as a fingerprint image input apparatus for acquiring an image of a fingerprint in an area of a finger in contact with the sweeping amount detection unit. Additionally, the sweeping amount detection unit may also serve as a fingerprint image input apparatus for acquiring an image of a fingerprint of a finger. Also, the sweeping amount detection unit may acquire the fingerprint image by illuminating the finger with light and detects the sweeping amount based on a change in the brightness of the fingerprint image.

According to another embodiment of the invention, there is provided an image input apparatus including an imaging unit including at least one line of image sensing elements, a light source adapted to illuminate an object to be examined with light, and an image forming unit configured to form, on the imaging unit, a blood vessel image obtained by passing the light through the object to be examined, the image input apparatus further including at least one reflection unit disposed between the object to be examined and the image forming unit, configured to reflect light from the inside of the object to be examined toward the image forming unit, and a sweeping amount detection unit configured to detect the sweeping amount of the object to be examined, by sequentially reading a plurality of image signals of respective partial blood vessel images taken by the imaging unit while sweeping the object to be examined, and detecting, as relative position data, the sweeping amount indicating the relative positional relationship among the plurality of image signals, for use in forming a complete blood vessel image from the partial blood vessel images represented by the respective read image signals.

The image input apparatus may further include a blood vessel image forming unit configured to form the complete blood vessel image by connecting the plurality of partial blood vessel images respectively represented by the plurality of image signals taken by the imaging unit in accordance with the sweeping amount of the object to be examined detected by the sweeping amount detection unit.

According to an another embodiment of the invention, there is provided a person authentication system including an image input apparatus according to one of the embodiments described above, a blood vessel image registration unit configured to register a blood vessel image read by the image input apparatus as identification information that identifies the object to be examined, and a blood vessel image checking unit configured to check whether the blood vessel image of the object to be examined read by the image input apparatus is identical to an image registered in the blood vessel image registration unit, and output the result of the check as a person authentication signal.

According to still yet another an embodiment of the invention, there is provided a person authentication system including a blood vessel image registration unit configured to register in advance a blood vessel image of an object to be examined read by an image input apparatus according to an embodiment as identification information of the object, and a blood vessel image checking unit configured to check whether the blood vessel image of the object to be examined read by the image input apparatus is identical to an image registered in the blood vessel image registration unit, and output the result of the check as a person authentication signal, the person authentication system further including a fingerprint image registration unit configured to register a fingerprint image read by the fingerprint image input apparatus as identification information that identifies the object to be examined, a fingerprint image checking unit configured to check whether the fingerprint image of the object to be examined read by the fingerprint image input apparatus is identical to an image registered in the fingerprint image registration unit, and output the result of the check as a person authentication signal, and a comprehensive checking apparatus adapted to evaluate the person authentication signal based on the blood vessel image and the person authentication signal based on the fingerprint image and produce a new person authentication signal according to an evaluation result.

As described above, the present invention provides an image input apparatus that can be produced in a small form at a low cost and that can acquire a high-precision image. The present invention also provides an image input apparatus that can be produced at a low cost and that can acquire an image with high precision even if a finger is swept at an inconstant speed.

Further embodiments, features and aspects of the present invention will become apparent from the following description of exemplary embodiments with reference to the attached drawings.

### BRIEF DESCRIPTION OF THE DRAWINGS

FIG. 1 is a schematic diagram of an exemplary blood vessel image input apparatus according to an embodiment of the present invention.

FIG. 2 illustrates an exemplary method of forming a complete image from a plurality of partial blood vessel images according to an embodiment of the present invention.

FIG. 3 is a schematic diagram of an exemplary blood vessel image input apparatus according to a second embodiment of the present invention.

FIG. 4 is a schematic diagram of an exemplary blood vessel image input apparatus according to a third embodiment of the present invention.

FIG. 5 is a schematic diagram of an exemplary blood vessel image input apparatus according to a fourth embodiment of the present invention.

FIG. 6 is a schematic diagram of an exemplary blood vessel image input apparatus according to a fifth embodiment of the present invention.

FIG. 7 is a block diagram of an exemplary person authentication apparatus according to a sixth embodiment of the present invention.

FIG. 8 is a block diagram of an exemplary blood vessel image input apparatus according to a seventh embodiment of the present invention.

FIG. 9 is a block diagram of an exemplary person authentication apparatus according to an eighth embodiment of the present invention.

FIG. 10 is a schematic diagram of an acquisition area of a finger image by a conventional two-dimensional image sensor.

FIG. 11 is a schematic diagram of an acquisition area of a finger image by a line image sensor.

FIG. 12 is a schematic diagram of an input apparatus for inputting an image of blood vessels of a finger according to a conventional technique.

### DESCRIPTION OF THE EMBODIMENTS

Various embodiments, features and aspects of a blood vessel image input apparatus and a person authentication system using a blood vessel image input apparatus according to the present invention are described with reference to the accompanying drawings.

### FIRST EXEMPLARY EMBODIMENT

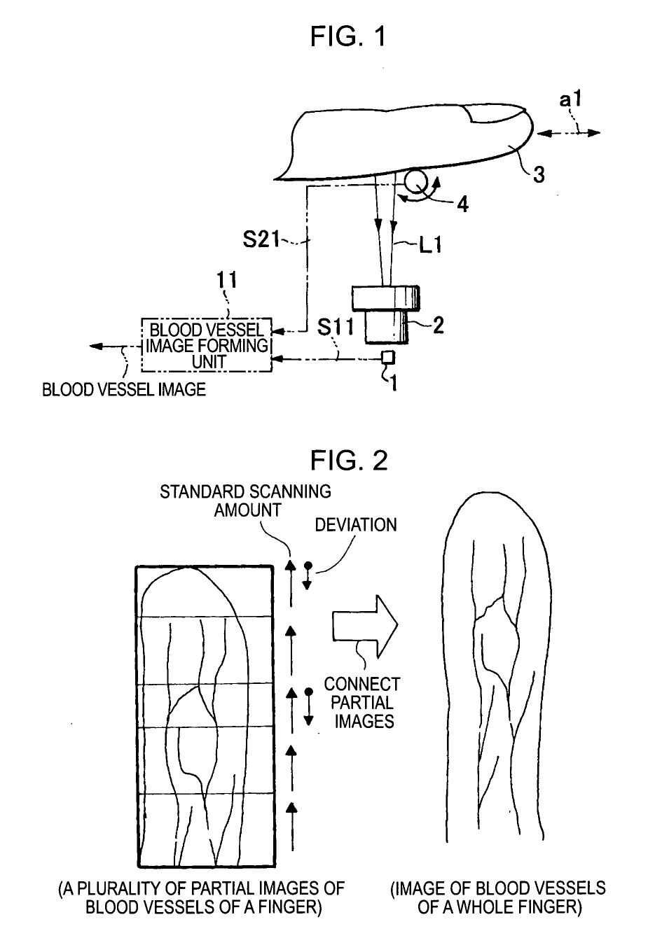

FIG. 1 shows a general structure of a blood vessel image input apparatus according to a first embodiment of the present invention. The blood vessel image input apparatus has an image reading plane whose area is smaller than the size of a finger 3 of a person to be authenticated. An image of a network structure of blood vessels of a finger is taken while the finger 3 is swept over the image reading plane in a direction perpendicular (see reference a1) to a main scanning direction of a solid-state line image sensor which will be described later. The blood vessel image input apparatus includes various parts described below.

A solid-state line image sensor 1 is provided for taking an image of blood vessels. An imaging optical system 2 is an optical lens or the like for focusing incident light on the surface of the solid-state line image sensor 1 such that an image is formed thereon. A roller-shaped rotating mechanism (sweeping amount detection unit) 4 is rotatable following the movement of the finger 3 in a state in which the roller-shaped rotating mechanism 4 is in contact with the finger 3. A blood vessel image forming unit 11 is connected to the solid-state image sensor 1 and the rotating mechanism 4.

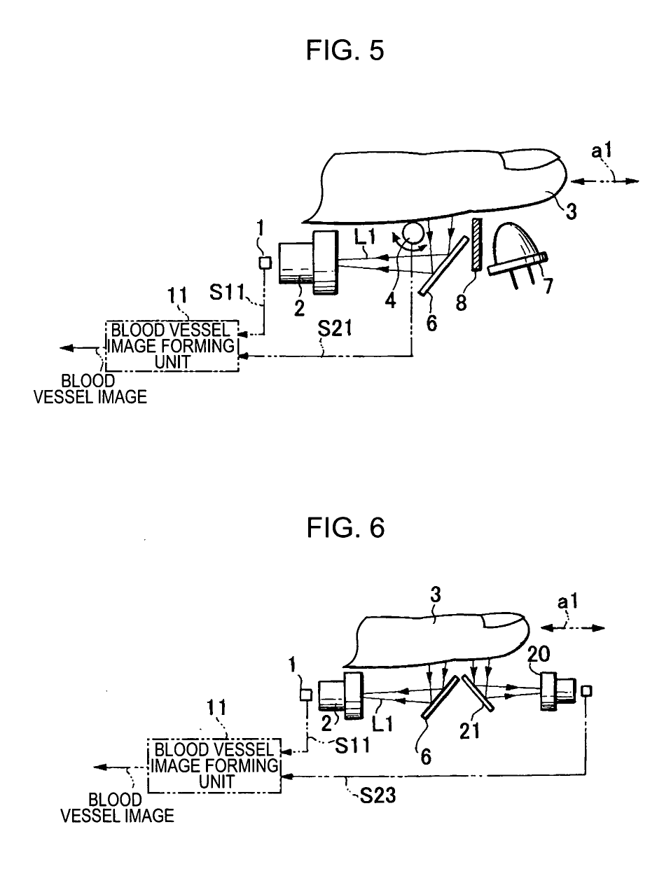

In addition, there is disposed a near-infrared light source (not shown), such as an LED (Light Emitting Diode), for emitting near-infrared light that passes through the inside of the finger 3. This light source is disposed at a proper position such that the inside of the finger 3 is illuminated with the near-infrared light emitted from the light source (the near-infrared light source will be described in further detail later with reference to FIG. 5).

The solid-state image sensor 1 includes a plurality of photosensors such as photodiodes disposed in a line. When the finger 3 is illuminated with near-infrared light emitted from a light source (not shown), the near-infrared light passes through the finger 3 while being scattered, and the near-infrared light is incident on the photosensors via the imaging optical system 2. The solid-state image sensor 1 reads an image signal S11 corresponding to charge amounts accumulated in respective photosensors depending on the intensity of incident light, and outputs the image signal S11 to the blood vessel image forming unit 11.

The roller-shaped rotating mechanism 4 includes, for example, a roller rotatable about an axis, and a detector connected to the rotation axis of the roller, for detecting the rotation speed of the roller and converting the rotation speed into an electrical signal. When the finger 3 is swept, the roller, kept in contact with the finger 3, rotates about the axis thereof depending on the sweeping amount. As the roller rotates, the detector detects the rotation speed of the roller and converts it into an electrical signal corresponding to the rotation speed. The detected value is output as a sweeping amount signal S21 to the blood vessel image forming unit 11.

The blood vessel image forming unit 11 includes a microprocessor or the like having a CPU (Central Processing Unit) that operates according to a program. The blood vessel image forming unit 11 performs various processes by executing a preinstalled program on the CPU. The blood vessel image forming unit 11 is formed integrally with a processing circuit in the solid-state image sensor 1 or integrally with a processing circuit in the rotating mechanism 4, although the blood vessel image forming unit 11 may be formed separately from the solid-state image sensor 1 and the rotating mechanism 4.

Now, referring to FIG. 1, the operation of the present embodiment is described. First, if a subject's finger 3 is placed on the image reading plane of the blood vessel image input apparatus, the finger 3 is illuminated with near-infrared light emitted from the near-infrared light source (not shown). When the near-infrared light passes through the finger, the near-infrared light is scattered. As a result, veins in the finger are illuminated with the near-infrared light passing through the finger 3. It is known that hemoglobin in veins absorbs more near-infrared light than other tissues in a finger. Therefore, by illuminating a finger with near-infrared light, it is possible to obtain an image showing the network structure of veins through which blood flows.

On the solid-state line image sensor 1, an image of veins in the finger is formed by the near-infrared light L1 from the inside of the finger via the imaging optical system 2. As a result, the image of veins with a network structure in the finger 3 (a partial vein image) is acquired by the solid-state line image sensor 1. An image signal S11 representing the acquired partial vein image of the finger is supplied to the blood vessel image forming unit 11.

The subject's finger 3 is then swept over the image reading plane in a direction perpendicular to the main scanning direction (the line direction) of the solid-state image sensor 1 (as represented by a double dashed line arrow al in FIG. 1). The sweeping of the finger 3 in the direction perpendicular to the main scanning direction of the solid-state image sensor 1 allows the image of veins in the finger to be continuously obtained. A plurality of resultant image signals S11 are output to the blood vessel image forming unit 11.

In the above-described process, when the finger 3 is swept, the roller-shaped rotating mechanism 4 rotates following the movement of the finger 3 and thus the sweeping amount (sweeping speed) of the finger 3 is detected by the rotating mechanism 4. A sweeping-amount signal S21 indicating the detected sweeping amount is output to the blood vessel image forming unit 11.

FIG. 2 illustrates an exemplary method of forming a complete image from a plurality of partial blood vessel images according to an embodiment of the present invention. The blood vessel image forming unit 11 connects the plurality of image signals S11 acquired by the solid-state image sensor 1, that is, partial images of veins in the finger 3, based on the sweeping-amount signal S21 supplied from the rotating mechanism 4 to obtain a complete image of veins with a network structure of the finger 3.

The distance between each two adjacent partial images is proportional to the sweeping speed of the finger 3. In other words, the distance between each two adjacent partial images of vessels varies depending on the sweeping speed of the finger. To handle the variation in the distance between each two adjacent partial images, a standard sweeping speed and a corresponding standard sweeping amount indicating a standard distance between two adjacent partial images of vessels are defined and stored in advance in a memory or the like. The difference between the sweeping speed of the finger 3 actually detected by the rotating mechanism 4 and the standard sweeping speed is calculated, and, based on the calculated difference, the deviation of the sweeping amount (relative distance) between each two adjacent partial images of vessels taken by the solid-state image sensor 1 from the standard sweeping amount (standard relative distance) is determined.

A complete image of blood vessels of the whole finger 3 can be produced by connecting each two adjacent partial images of blood vessels based on the determined deviation. The above-described process is performed by the blood vessel image forming unit 11 by executing the program stored in advance in the memory or the like.

In the present embodiment, as described above, because the solid-state line image sensor is used, the image sensing area does not need to have a size corresponding to the whole finger, and thus this structure allows a reduction in the size of the apparatus. Another advantage is that because the sweeping amount of a finger is detected using the roller-shaped rotating mechanism 4 and a complete image is produced by connecting a plurality of partial images based on the detected sweeping amount, the finger blood vessel image input apparatus can obtain a high-precision blood vessel image of the whole finger, even if the sweep speed of the finger is not constant.

The rotating mechanism 4 shown in FIG. 1 may be constructed in the form of a transparent cylindrical roller, and one-dimensional imaging optical system and one-dimensional photoelectric converter may be disposed in the cylindrical roller. This makes it possible to acquire an image of a finger surface based on the difference in light intensity between a part of the finger surface in contact with the surface of the transparent cylindrical roller and a noncontacting part. Furthermore, a photoelectric converter with a sufficiently high resolution may also be disposed in the cylindrical roller to acquire a fingerprint image of the finger. This makes it possible to realize a biometric image input apparatus capable of acquiring both a fingerprint image and a blood vessel image.

### SECOND EXEMPLARY EMBODIMENT

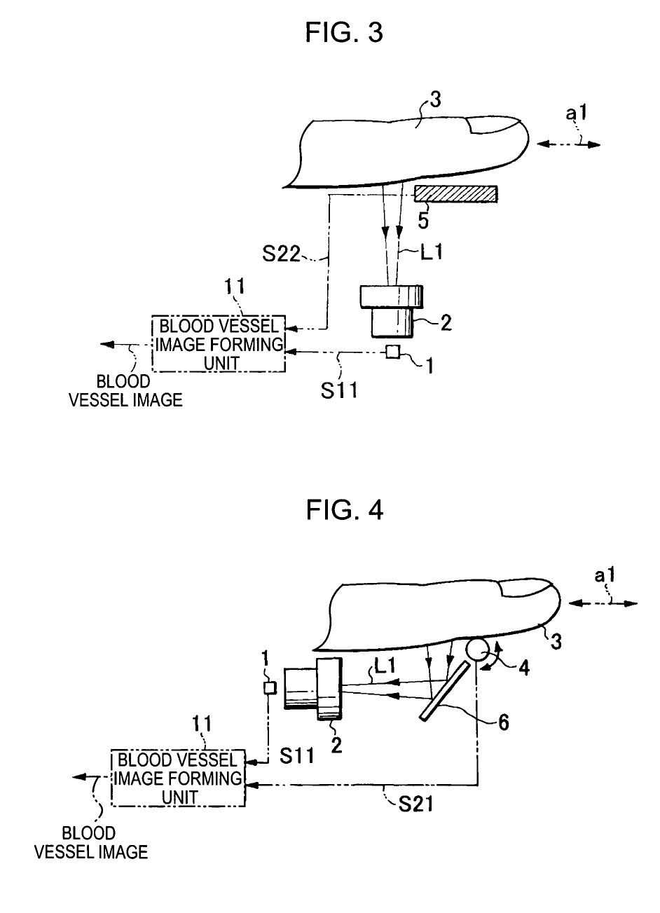

FIG. 3 shows a general structure of another exemplary blood vessel image input apparatus according to a second embodiment of the present invention. The blood vessel image input apparatus according to the second embodiment shown in FIG. 3 is similar to that according to first embodiment except that a contact-type optical position sensor 5 is used as the sweeping amount detection unit.

The optical position sensor 5 includes various parts as described below. That is, the optical position sensor 5 has a light source that illuminates the inside of a finger placed close to the position sensor. The optical position sensor 5 also has one-dimensional or two-dimensional photoelectric converter including at least one line array of photoelectric conversion elements. The optical position sensor 5 also has a protective member such as a fiber plate or a thin silicon film disposed on the surface of the photoelectric converter so that the photoelectric converter is protected and so that the difference in light intensity between an area with which the finger is in contact and an area with which the finger is not in contact.

When the finger 3 is swept in a state in which the finger 3 is kept in contact with the optical position sensor 5, the light intensity changes as the contacting part between the finger and the photoelectric converter moves, and the movement of the contacting part is detected based on the change in the light intensity. The detected value is supplied as a sweeping amount signal S22 to the blood vessel image forming unit 11.

Now, referring to FIG. 3, the operation of the present embodiment is described. First, if a subject's finger 3 is placed on the image reading plane of the blood vessel image input apparatus, the finger 3 is illuminated with near-infrared light emitted from the near-infrared light source (not shown). When the near-infrared light passes through the finger, the near-infrared light is scattered. As a result, veins in the finger are illuminated with the near-infrared light passing through the finger 3. As already discussed, it is known that hemoglobin in veins absorbs more near-infrared light than other tissues in a finger. Therefore, by illuminating a finger with near-infrared light L1, it is possible to obtain an image showing the network structure of veins through which blood flows.

On the solid-state line image sensor 1, an image of veins in the finger is formed by the near-infrared light L1 from the inside of the finger via the imaging optical system 2. As a result, the image of veins with a network structure in the finger 3 (a partial vein image) is acquired by the solid-state line image sensor 1. An image signal S11 representing the acquired partial vein image of the finger is supplied to the blood vessel image forming unit 11.

The subject's finger 3 is then swept over the image reading plane in a direction perpendicular to the main scanning direction (the line direction) of the solid-state image sensor 1 (as represented by a double dashed line arrow al in FIG. 1). The sweeping of the finger 3 in the direction perpendicular to the main scanning direction of the solid-state image sensor 1 allows the image of veins in the finger to be continuously obtained. A plurality of resultant image signals S11 are output to the blood vessel image forming unit 11.

In the above process, when the finger 3 is swept over the optical position sensor 5, the optical position sensor 5 detects the sweeping amount (sliding speed) of the finger 3 and outputs a sweeping amount signal S22 indicating the detected sweeping amount to the blood vessel image forming unit 11.

The blood vessel image forming unit 11 connects the plurality of image signals S11 acquired by the solid-state image sensor 1, that is, partial images of veins in the finger 3, based on the sweeping amount signal S22 supplied from the contact-type optical position sensor 5 to obtain a complete image of veins with a network structure of the finger 3.

In the present embodiment, as described above, because the solid-state line image sensor 1 is used, the image sensing area does not need to have a size corresponding to the whole finger, and thus this structure allows a reduction in the size of the apparatus. Furthermore, because the sweeping amount of the finger is detected using the contact-type optical position sensor 5 and a plurality of images are connected in accordance with the sweeping amount, even if the sweep speed of the finger is not constant, the finger blood vessel image input apparatus can obtain a high-precision blood vessel image of a whole finger.

Although in the present embodiment, the contact-type optical position sensor 5 is used as the sweeping amount detection unit configured to detect the sweeping amount of a finger, a contact-type capacitive position sensor may be used instead of the optical position sensor.

The contact-type capacitive position sensor has a structure in which one-dimensional or two-dimensional array of small electrodes including at least one line of electrodes is formed on a silicon substrate and the array of electrodes is covered with a protective film. The contact-type capacitive position sensor also includes a capacitance detector adapted to detect the capacitance between each electrode and a finger (which can be regarded as a conductor). When the finger 3 is swept over the contact-type capacitive position sensor in a state in which the capacitive position is kept in contact with the finger 3, the capacitance changes depending on the sweeping amount. The capacitance change is detected by the capacitive position sensor, and the movement of the finger is detected based on the detected capacitance change. The detected movement is output as a sweeping amount signal S22 to the blood vessel image forming unit 11.

Also in this case, as with the optical position sensor according to the above-described embodiment of the invention, it is possible to acquire a complete image by connecting partial images each having a band-like area, based on the sweeping amount of the finger 3 detected by the contact-type capacitive position sensor. Thus, using the contact-type capacitive position sensor, it is possible to realize a blood vessel image input apparatus capable of acquiring a complete image of blood vessels of a finger.

If the electrodes of the capacitive position sensor are formed so as to acquire a high-resolution image that allows a detection of surface topography of a fingerprint, it becomes possible to acquire a fingerprint image of a finger, and it also becomes possible to detect the movement of the finger from the movement of the fingerprint image. Furthermore, it also becomes possible to obtain a complete image of a finger by connecting a plurality of partial images of blood vessels detected by the solid-state line image sensor in accordance with the movement of the finger detected from the acquired fingerprint image. Thus, it is possible to realize a biometric image input apparatus capable of simultaneously acquiring a plurality of different types of biometric images.

### THIRD EXEMPLARY EMBODIMENT

FIG. 4 shows a general structure of an exemplary blood vessel image input apparatus according to a third embodiment of the present invention. A solid-state line image sensor 1 is used as an imaging unit, and an optical path is folded in an optical axis direction perpendicular to the main scanning direction of the solid-state line image sensor 1. That is, as shown in FIG. 4, the blood vessel image input apparatus according to the present embodiment includes, in addition to the parts used in the first embodiment, at least one reflecting mirror 6 serving as a reflection unit, and the positions of the imaging optical system 2 and the solid-state line image sensor 1 are modified.

The reflecting mirror 6 reflects near-infrared light L1 from a finger 3 in a direction with a predetermined angle (about 90 degrees in the example shown in FIG. 4) thereby changing the optical path. After the optical path of the near-infrared light L1 is changed by the reflecting mirror 6, the near-infrared light L1 is incident on the imaging optical system 2, which focuses the near-infrared light L1 on the light sensing surface of the solid-state line image sensor 1. Except for the above-described difference, the structure and the operation are similar to those of the first embodiment, and thus an explanation thereof is omitted.

As can be understood from the above discussion, the present embodiment provides not only advantages similar to those provided by the first embodiment described above but also an additional advantage that use of the reflecting mirror 6 allows the optical path including the solid-state line image sensor and the imaging optical system to be folded within a small space. Thus, it is possible to realize a blood vessel image input apparatus in a thin and small form.

### FOURTH EXEMPLARY EMBODIMENT

FIG. 5 shows a general structure of an exemplary blood vessel image input apparatus according to a fourth embodiment of the present invention. The blood vessel image input apparatus includes, in addition to the parts used in the first or third embodiment, a light blocking plate 8 disposed between the reflecting mirror 6 and the near-infrared light source 7 such that light emitted from the near-infrared light source 7 and reflected from the surface of a finger does not directly reach the solid-state line image sensor 1. In this structure, by illuminating a finger with near-infrared light L1, it is possible to obtain an image showing the network structure of veins through which blood flows. Except for the above-described difference, the structure and the operation are similar to those of the first or third embodiment, and thus an explanation thereof is omitted.

As can be understood from the above discussion, the present embodiment provides not only advantages similar to those provided by the first or third embodiment described above but also an additional advantage that the finger can be illuminated with near-infrared light emitted from the light source disposed close to the image sensing area, and thus it is possible to realize the blood vessel image input apparatus including the light source in a smaller and thinner form.

### FIFTH EXEMPLARY EMBODIMENT

FIG. 6 shows a general structure of an exemplary blood vessel image input apparatus according to a fifth embodiment of the present invention. Here, a non-contact optical encoder 20 is used as a sweeping amount detection unit configured to detect the sweeping amount of'a finger from an intensity change of an image corresponding to the surface topography of the finger. The blood vessel image input apparatus also includes a reflecting mirror 21 disposed at the back of the reflecting mirror 6 for forming a blood vessel image. The non-contact optical encoder 20 is disposed at a location apart from the finger 3 such that light L1 whose optical path is changed by the reflecting mirror 21 by a proper angle (for example, 900) is incident on the non-contact optical encoder 20.

The optical encoder 20 includes an imaging optical system and a solid-state image sensor. When the finger 3 is swept, light is focused on the solid-state image sensor by the imaging optical system via the reflecting mirror such that the image of the surface topography of a fingerprint or a wrinkle on the surface of the finger 3 is formed on the image sensing surface of the solid-state image sensor. Based on the change in intensity of the image, the movement of the image is detected. The sweeping amount or the sweep speed of the finger 3 is determined from the movement of the image, and a sweeping-amount signal S23 indicating the detected sweeping amount is output to the blood vessel image forming unit 11. Except for the above-described difference, the structure and the operation are similar to those of the first or third embodiment, and thus an explanation thereof is omitted.

In cooperation with an additional light source, as shown in FIG. 6, the optical encoder 20 may acquire an image of a part of the finger 3 from its top joint to its tip such that an image with a sufficiently high resolution of a fingerprint of the surface of the finger is formed on the solid-state image sensor. That is, the optical encoder 20 may be formed so as to also function as a non-contact fingerprint image input apparatus. Thus, it is possible to realize a biometric image input apparatus capable of simultaneously inputting a blood vessel image and a fingerprint image.

In a case where the blood vessel image input apparatus includes a plurality of lines, the blood vessel image input apparatus may also function as a sweeping amount detector. In this case, it is possible to connect partial images of blood vessels while detecting the sweeping amount from the partial images so as to acquire a complete image of blood vessels a finger.

Alternatively, the sweeping amount of the finger may be acquired from the blood vessel image input apparatus, and a plurality of images each including at least one line acquired from the fingerprint image input apparatus realized by the solid imaging unit including at least one line may be connected to acquire a complete fingerprint image of a finger.

As can be understood from the above discussion, the present embodiment provides not only advantages similar to those provided by the first or third embodiment described above but also an additional advantage that by using the non-contact optical encoder as the sweeping amount detection unit, it is possible to realize the sweeping amount detection unit capable of detecting the sweeping amount in a state in which the sweeping amount detection unit is not in contact with the finger. This provides a greater number of options in designing of the apparatus.

### SIXTH EXEMPLARY EMBODIMENT

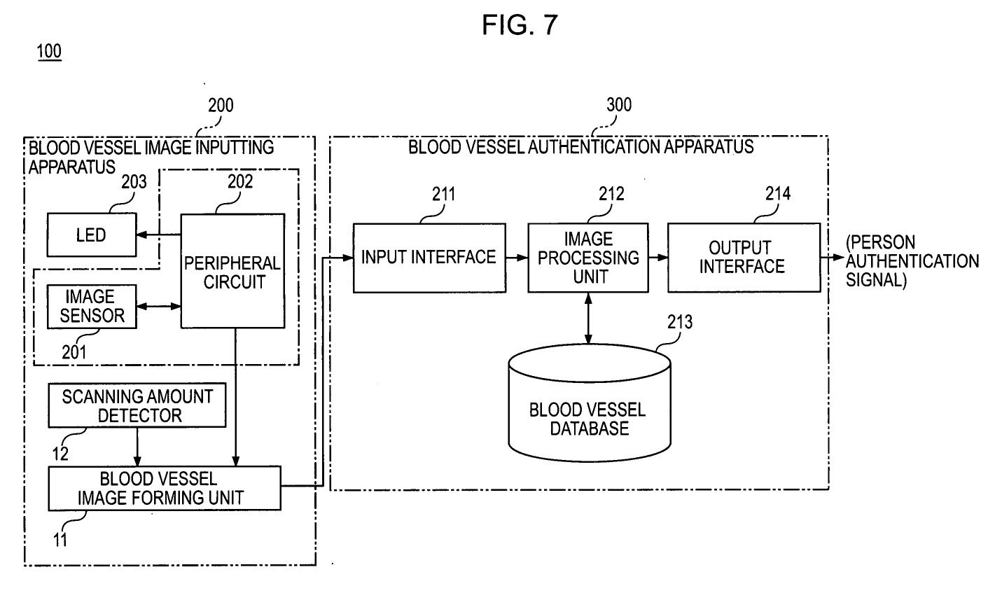

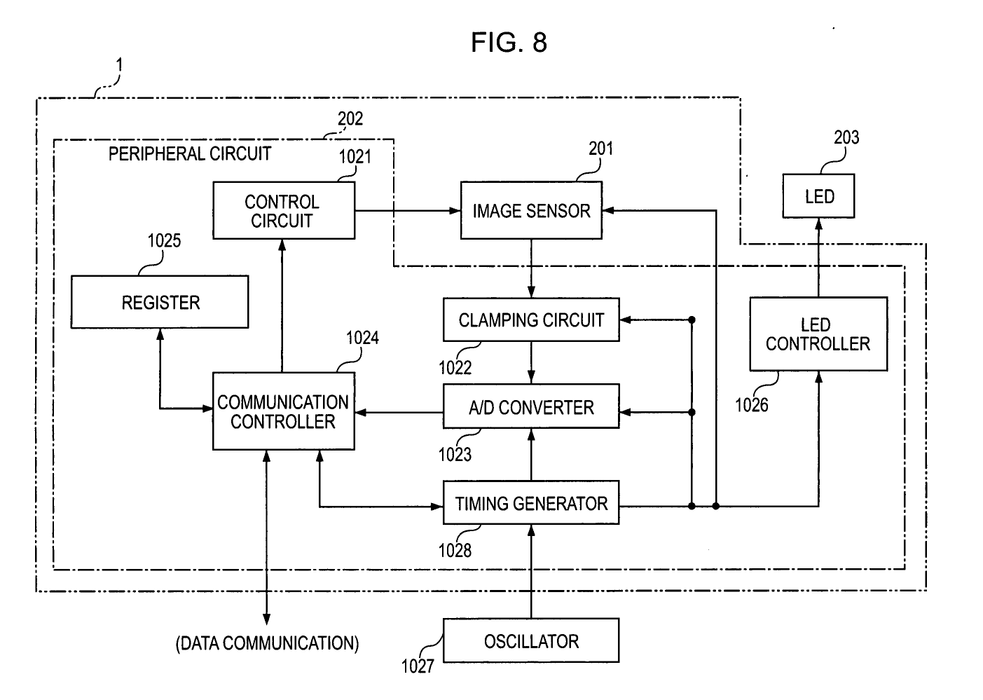

An embodiment of a person authentication system 100 using the above-described blood vessel image input apparatus is described below with reference to FIGS. 7 and 8.

The person authentication system 100 includes a blood vessel image input apparatus 200 including an imaging unit 201 with the above-described solid-state image sensor 1, a peripheral circuit 202, an LED 203 in the form of an LED chip, a sweeping/scanning amount detector 12, and a blood vessel image forming unit 11. The person authentication system 100 further includes a blood vessel image checking apparatus 300 connected to the blood vessel image input apparatus 200.

The sweeping amount detector 12 is formed using, for example, the roller-shaped mechanism 4, the optical position sensor 5, or the optical encoder 20. The blood vessel image forming unit 11 may be formed integrally with the peripheral circuit 202, as long as the function of the blood vessel image forming unit 11 is achieved.

The peripheral circuit 202 may be formed in the solid-state image sensor 1. As shown in FIG. 8, the peripheral circuit 202 includes the following parts. A control circuit (a drive circuit) 1021 controls the operation of the solid-state image sensor 201. An A/D converter 1023 converts, into a digital signal, an analog image signal representing an image of blood vessels of a finger received from the imaging unit 201 via a clamping circuit 1022. A communication controller 1024 controls data communication to transmit the digital signal output from the A/D converter 1023 to an external device (such as an interface) as the image signal of the blood vessels. A register 1025 is connected to the communication controller 1024. An LED controller 1026 controls turning on/off an LED 203. A timing generator 1028 generates a control pulse to control the operation timing of circuits 1021 to 1026 in accordance with a reference pulse supplied from an external oscillator 1027. The circuits included in the peripheral circuit 202 are not limited to those described above, rather, the peripheral circuit 202 may include other circuits. One or more of the circuits may be formed separately on another chip.

The blood vessel image checking apparatus 300 includes the following parts. An input interface 211 is an unit for inputting communication data output from a communication controller in the peripheral circuit 202. An image processing unit. (blood vessel image checking unit) 212 is connected to the input interface 211. A blood vessel image database (or blood vessel image registration unit) 213 and an output interface 214 are connected to the image processing unit 212. The output interface 214 is connected to an electronic device (which may be implemented by software) that needs person authentication for security when a user uses or access the electronic device.

Blood vessel images of persons to be authenticated are registered in advance in the blood vessel image database 213. Note that there is no particular restriction on the number of persons whose blood vessel image is registered in the blood vessel image database 213. When an initial setting is performed or when blood vessel images are added, blood vessel images of persons are captured by the blood vessel image input apparatus 200 and are input as person authentication information via the input interface 211.

If the image processing unit 212 receives, via the input interface 211, a blood vessel image read by the blood vessel image input apparatus 200, the image processing unit 212 checks whether the image is identical to an image registered in the blood vessel image database 213 in accordance with a known blood vessel image checking algorithm. A person authentication signal indicating the result of the check (indicating whether the blood vessel image is identical to a registered image) is output via the output interface 214.

Although in the present embodiment, the blood vessel image input apparatus 200 and the blood vessel image checking apparatus 300 are packaged in a separate manner, they may be packaged differently. For example, one or more functions of the blood vessel image checking apparatus 300 may be integrally implemented in the peripheral circuit 202 of the blood vessel image input apparatus 200. Also, the person authentication system 100 may be disposed separately from or integrally in an electronic device that needs personal authentication.

### SEVENTH EXEMPLARY EMBODIMENT

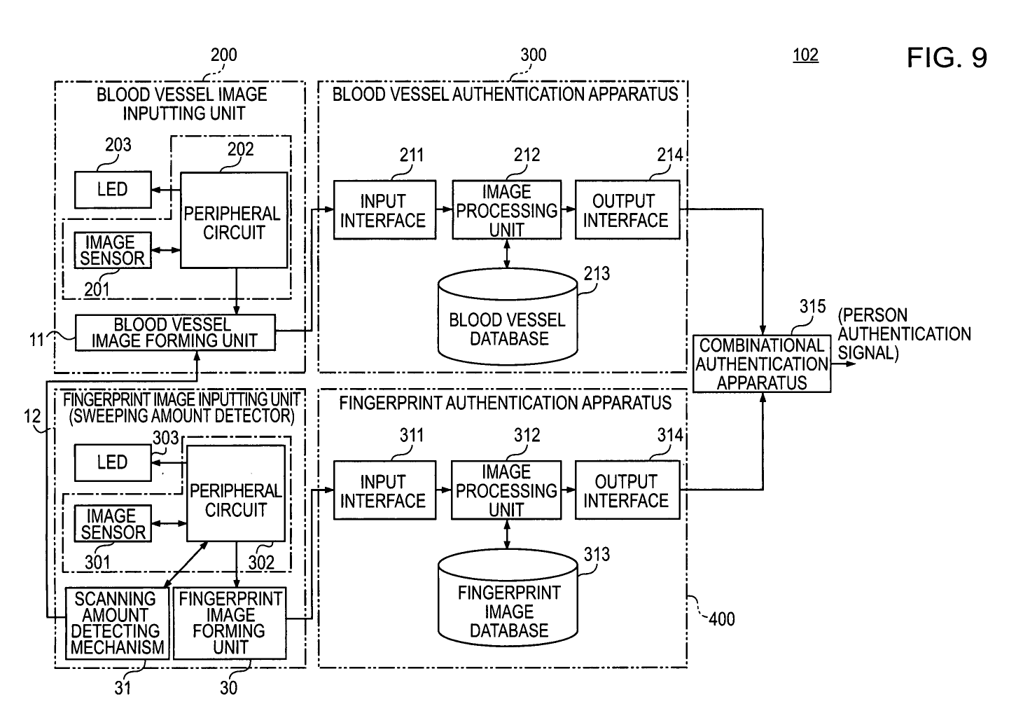

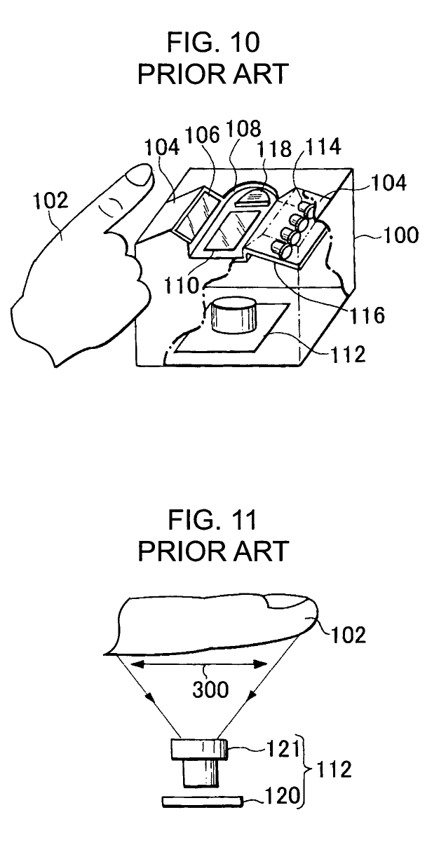

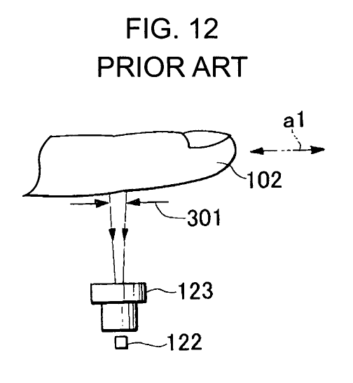

Now, referring to FIG. 9, an exemplary person authentication system 102 using a blood vessel image input apparatus according to a seventh embodiment of the invention is described below.

In the seventh embodiment, the person authentication system 102 has a blood vessel image input apparatus 200 including an imaging unit 201 with the above-described solid-state image sensor 1, a peripheral circuit 202, an LED 203 in the form of an LED chip, a fingerprint image input apparatus 12 also functioning as a sweeping amount detector, and a blood vessel image forming unit 11.

The person authentication system 102 further includes a blood vessel image checking apparatus 300 connected to the blood vessel image input apparatus 200. Note that the sweeping amount detector 12 (the fingerprint image input apparatus) also functions as an optical position sensor. The blood vessel image forming unit 11 may be formed integrally with the peripheral circuit 202, as long as the function of the blood vessel image forming unit 11 is achieved.

The sweeping amount detector 12, which also serves as the fingerprint image input apparatus, includes an imaging unit 301, a peripheral circuit 302, an LED 303 serving as a light source of the optical position sensor, a scanning amount detecting mechanism 31 configured to detect the sweeping amount of the finger from fingerprint image information obtained by the imaging unit 301, and a fingerprint image forming unit 30. The sweeping amount detector 12 inputs a fingerprint image and supplies the sweeping amount of the finger detected by the sweeping amount detecting mechanism 31 to the blood vessel image forming unit of the blood vessel image forming apparatus 200. Based on the supplied sweeping amount of the finger, the blood vessel image input apparatus 200 produces a complete image of blood vessels by connecting a plurality of partial images.

The operation of the blood vessel image input apparatus 102 is similar to that according to the sixth embodiment described above, and thus a duplicated explanation thereof is not given here.

The blood vessel image checking apparatus 300 includes the following parts. An input interface 211 is an unit for inputting communication data output from a communication controller of the peripheral circuit 202. An image processing unit (blood vessel image checking unit) 212 is connected to the input interface 211. A blood vessel image database (blood vessel image registration unit) 213 is connected to the image processing unit 212. The blood vessel image checking apparatus 300 also includes an output interface 214.

The fingerprint image checking apparatus 400, which receives a fingerprint image from the fingerprint image input apparatus, includes the following parts. An input interface 311 is an unit for inputting communication data output from a communication controller of the peripheral circuit 302. An image processing unit (fingerprint image checking unit) 312 is connected to the input interface 311. A fingerprint image database (fingerprint image registration unit) 313 and an output interface 314 are connected to the image processing unit 312. The output interfaces 214 and 314 are connected to a comprehensive checking apparatus 315. A person authentication signal is output from the comprehensive checking apparatus 315 to an electronic device (which may be implemented by software) that needs person authentication for security when a user uses or access the electronic device.

Blood vessel images of persons to be authenticated are registered in advance in the blood vessel image database 213. Note that there is no particular restriction on the number of persons whose blood vessel image is registered in the blood vessel image database 213. When an initial setting is performed or when fingerprint images are added, fingerprint images of persons are captured by the blood vessel image input apparatus 200 and are input as person authentication information via the input interface 211.

If the image processing unit 212 receives, via the input interface 211, a blood vessel image read by the blood vessel image input apparatus 200, the image processing unit 212 checks whether the image is identical to an image registered in the blood vessel image database 213 in accordance with a known blood vessel image checking algorithm. A person authentication signal indicating the result of the check (indicating whether the blood vessel image is identical to a registered image) is output via the output interface 214.

Fingerprint images of persons to be authenticated are registered in advance in the fingerprint image database 313. Note that there is no particular restriction on the number of persons whose fingerprint image is registered in the fingerprint image database 313. When an initial setting is performed or when fingerprint images are added, fingerprint images of persons are captured by the fingerprint image input apparatus 300 and are input as person authentication information via the input interface 311.

If the image processing unit 312 receives, via the input interface 311, a fingerprint image read by the fingerprint image input apparatus 300, the image processing unit 312 checks whether the image is identical to an image registered in the fingerprint image database 313 in accordance with a known fingerprint image checking algorithm. A person authentication signal indicating the result of the check (indicating whether the fingerprint image is identical to a registered image) is output via the output interface 314. The comprehensive checking apparatus 315 evaluates the person authentication signals respectively received from the output interfaces 314 and 314, and outputs one of the person authentication signals or a final person authentication signal based on the evaluation result.

Although in the present embodiment, the blood vessel image input apparatus 200 and the blood vessel image checking apparatus 300 are packaged in a separate manner, they may be packaged differently. For example, one or more functions of the blood vessel image checking apparatus 300 may be integrally implemented in the peripheral circuit 202 of the blood vessel image input apparatus 200.

Although in the present embodiment, the fingerprint image input apparatus 12 and the fingerprint image checking apparatus 400 are packaged in a separate manner, they may be packaged differently. For example, one or more functions of the fingerprint image checking apparatus 400 may be integrally implemented in the peripheral circuit 302 of the fingerprint image input apparatus 12. The person authentication system may be disposed separately from or integrally in an electronic device that needs personal authentication.

As described above, the present invention can be advantageously applied to a blood vessel image input apparatus adapted to input an image of blood vessels of a finger for personal authentication and to a person authentication system using such a blood vessel image input apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-033091 filed Feb. 9, 2005, which is hereby incorporated by reference herein in its entirety.

What is claimed is:

1. An image input apparatus comprising:
an imaging device including at least one line of image sensing elements, and a light source adapted to illuminate a body part to be examined with light, whereby an image of blood vessels within the body part is acquired by passing the light through the inside of the body part to be examined, and the image is captured by the imaging device,
wherein a plurality of image signals of respective partial images of blood vessels captured by the imaging device are sequentially read while sweeping the body part to be examined, and a complete image of blood vessels is formed by connecting the partial images of blood vessels represented by the respective read image signals.

2. The image input apparatus according to claim 1, further comprising a sweeping amount detection unit configured to detect the sweeping amount of the body part to be examined.

3. The image input apparatus according to claim 2, further comprising a blood vessel image forming unit configured to form a complete blood vessel image by connecting the plurality of partial blood vessel images, depending on the sweeping amount of the body part to be examined detected by the sweeping amount detection unit.

4. The image input apparatus according to claim 3, wherein the sweeping amount detection unit detects the sweeping amount in a state in which the sweeping amount detection unit is in contact with the body part to be examined.

5. The image input apparatus according to claim 4, wherein the sweeping amount detection unit is at least one of a contacting and rotating roller.

6. The image input apparatus according to claim 4, wherein the sweeping amount detection unit is a contact-type optical position sensor.

7. The image input apparatus according to claim 4, wherein the sweeping amount detection unit is a contact-type capacitive position sensor.

8. The image input apparatus according to claim 3, wherein the sweeping amount detection unit detects the sweeping amount in a state in which the sweeping amount detection unit is not in contact with the body part to be examined.

9. The image input apparatus according to claim 8, wherein the sweeping amount detection unit illuminates the surface of the body part to be examined with light and detects the sweeping amount based on a change in the image of the surface shape of the body part to be examined.

10. The image input apparatus according to claim 4, wherein the sweeping amount detection unit also serves as a fingerprint image input apparatus for acquiring an image of a fingerprint in an area of a finger in contact with the sweeping amount detection unit.

11. The image input apparatus according to claim 8, wherein the sweeping amount detection unit also serves as a fingerprint image input apparatus for acquiring an image of a fingerprint of a finger.

12. The image input apparatus according to claim 11, wherein the sweeping amount detection unit acquires the fingerprint image by illuminating the finger with light and detects the sweeping amount based on a change in the brightness of the fingerprint image.

13. The image input apparatus according to claim 1, wherein the body part is one of a finger or thumb.

14. The image input apparatus according to claim 1, wherein the body part is a body limb.

15. An image input apparatus comprising:
an imaging device including at least one line of image sensing elements, a light source adapted to illuminate a body part to be examined with light;
an image forming unit configured to form a blood vessel image obtained by passing the light through the body part to be examined;
at least one reflection unit, configured to be disposed between the body part to be examined and the image forming unit, for reflecting light from the inside of the body part to be examined toward the image forming unit; and
a sweeping amount detection unit configured to detect the sweeping amount of the body part to be examined, by sequentially reading a plurality of image signals of respective partial blood vessel images taken by the imaging device while sweeping the body part to be examined, and detect, as relative position data, the sweeping amount indicating the relative positional relationship among the plurality of image signals, for use in forming a complete blood vessel image from the partial blood vessel images represented by the respective read image signals.

16. The image input apparatus according to claim 15, further comprising a blood vessel image forming unit configured to form the complete blood vessel image by connecting the plurality of partial blood vessel images respectively represented by the plurality of image signals taken by the image device in accordance with the sweeping amount of the body part to be examined detected by the sweeping amount detection unit.

17. A person authentication system comprising:
an image input apparatus including an imaging device including at least one line of image sensing elements, and a light source adapted to illuminate a body part to be examined with light, whereby an image of blood vessels within the body part is acquired by passing the light through the inside of the body part to be examined, and the image is captured by the image device, wherein a plurality of image signals of respective partial images of blood vessels captured by the imaging device are sequentially read while sweeping the body part to be examined, and a complete image of blood vessels is formed by connecting the partial images of blood vessels represented by the respective read image signals;
a blood vessel image registration unit configured to register a blood vessel image read by the image input apparatus as identification information that identifies the body part to be examined; and
a blood vessel image checking unit configured to check whether the blood vessel image of the object to be examined read by the image input apparatus is identical to an image registered in the blood vessel image registration unit, and output the result of the check as a person authentication signal.

18. A person authentication system comprising:
an image input apparatus comprising,
an imaging device including at least one line of image sensing elements, and a light source adapted to illuminate a body part to be examined with light, whereby an image of blood vessels within the body part is acquired by passing the light through the inside of the body part to be examined, and the image is captured by the image device, wherein a plurality of image signals of respective partial images of blood vessels captured by the imaging device are sequentially read while sweeping the body part to be examined, and a complete image of blood vessels is formed by connecting the partial images of blood vessels represented by the respective read image signals;
a sweeping amount detection unit configured to detect the sweeping amount of the body part to be examined, wherein the sweeping amount detection unit detects the sweeping amount in a state in which the sweeping amount detection unit is in contact with the body part to be examined, wherein the sweeping amount detection unit also serves as a fingerprint image input apparatus for acquiring an image of a fingerprint in an area of a finger in contact with the sweeping amount detection unit; and
a blood vessel image forming unit configured to form a complete blood vessel image by connecting the plurality of partial blood vessel images, depending on the sweeping amount of the body part .to be examined detected by the sweeping amount detection unit;
a blood vessel image registration unit configured to register in advance a blood vessel image of the body part to be examined by the image input apparatus as identification information of the body part;
a blood vessel image checking unit configured to check whether the blood vessel image of the body part to be examined read by the image input apparatus is identical to an image registered in the blood vessel image registration unit, and output the result of the check as a person authentication signal;
a fingerprint image registration unit configured to register a fingerprint image read by the fingerprint image input apparatus as identification information that identifies the body part to be examined;
a fingerprint image checking unit configured to check whether the fingerprint image of the body part to be examined read by the fingerprint image input apparatus is identical to an image registered in the fingerprint image registration unit, and outputting the result of the check as a person authentication signal; and
a checking device adapted to evaluate the person authentication signal based on the blood vessel image and the person authentication signal based on the fingerprint image and produce a new person authentication signal according to an evaluation result.
